(19) United States
(12) Patent Application Publication
(10) Pub. No.: US 2017/0301051 A1
(43) Pub. Date: Oct. 19, 2017

(54) MEDIA SHARING APPLICATION WITH GEOSPATIAL TAGGING FOR CROWDSOURCING OF AN EVENT ACROSS A COMMUNITY OF USERS

(71) Applicant: PICPOCKET, INC., Dallas, TX (US)

(72) Inventor: Wolfram K. Gauglitz, Dallas, TX (US)

(73) Assignee: PICPOCKET, INC., Dallas, TX (US)

(21) Appl. No.: 15/194,562

(22) Filed: Jun. 27, 2016

Related U.S. Application Data
(60) Provisional application No. 62/099,644, filed on Jan. 5, 2015.
(60) Provisional application No. 62/184,663, filed on Jun. 25, 2015.

(51) Int. Cl. G06Q 50/26; G06Q 50/00; H04W 4/02

(52) U.S. Cl. CPC G06Q 50/26; G06Q 50/01; H04W 4/02

(57) ABSTRACT

A method is provided for rescuing an animal trapped in a vehicle. The method includes providing an application which a user may utilize to report incidences of animals trapped in vehicles; receiving an indication from a user of the application that an incident has occurred in which an animal is trapped in a vehicle; obtaining from the user information including (a) the location of the vehicle in which the animal is trapped, and (b) identifying characteristics of the vehicle; and sending an alert about the incident to an animal rescue authority, said alert including the information obtained from the user.

### CROSS-REFERENCE TO RELATED APPLICATIONS

This application claims priority from U.S. Provisional Application 62/184,663, filed on Jun. 25, 2015, having the same title and inventors, and which is incorporated herein by reference in its entirety.

### FIELD OF THE DISCLOSURE

The present disclosure relates generally to media sharing and aggregation, and more particularly to systems, methods and mobile applications which facilitate the crowdsourcing of an event across a community of users through the timely provision of relevant media or information.

### BACKGROUND OF THE DISCLOSURE

Every year, large numbers of dogs and other domesticated animals die or suffer serious injuries as a result of being left unattended in vehicles. Even on a mild day, the temperatures inside of a vehicle can climb to dangerous levels in a matter of minutes. While several grass roots movements have evolved to promote public awareness of this issue, the problem still persists.

Several factors may contribute to the number of incidents in which animals become trapped in vehicles under dangerous conditions. In many cases, the owner of an animal may simply forget that they have left their animal in a vehicle for a significant period of time. This may occur, for example, if the owner ends up being away from the vehicle for longer than originally intended, or if the owner simply loses sight of the amount of time that has elapsed since the animal was first left in the vehicle. The owner of the animal may also misjudge the severity of the conditions to which the animal is exposed inside of the vehicle. Unfortunately, animal injury or death may occur in a matter of minutes when temperatures inside of a vehicle become elevated or depressed. Consequently, time is typically of the essence in dealing with such incidents.

While public awareness of these issues may help to reduce the number of incidents in which animals die or suffer serious injuries as a result of being trapped in vehicles, it is unlikely to eliminate such incidents altogether. In particular, public awareness campaigns may not eliminate incidents which arise from negligence, human error or unavoidable circumstances.

### BRIEF DESCRIPTION OF THE DRAWINGS

FIGS. 1-15 are screenshots from a particular, non-limiting embodiment of a mobile application which may be utilized to implement the systems and methodologies described herein.

### SUMMARY OF THE DISCLOSURE

In one aspect, a method is provided for rescuing an animal trapped in a vehicle. The method comprises (a) providing an application which users can utilize to report incidences of animals trapped in vehicles; (b) receiving an indication from a user of the application that an incident has occurred in which an animal is trapped in a vehicle; (c) prompting the user for information relating to the incident, said information including the location of the vehicle in which the animal is trapped; and (d) sending an alert about the incident to an animal rescue authority, said alert including the information obtained from the user. In another aspect, a method for rescuing an animal trapped in a vehicle is provided. The method comprises (a) obtaining a mobile communications device having an application thereon which, upon launch, generates a dialog stream with the user, wherein the dialog stream prompts the user to capture media and to assign each instance of the captured media into one of a plurality of predefined categories, and wherein the predefined categories relate to at least one of (i) the location of a vehicle in which an animal is trapped, and (ii) identifying characteristics of the vehicle; (b) utilizing the application to capture and categorize media; and (c) forwarding the captured media to an authority tasked with animal rescues.

In another aspect, a method for rescuing an animal trapped in a vehicle is provided. The method comprises (a) providing a mobile application for a mobile communications device; (b) generating a dialog stream with the user upon launch of the application, wherein the dialog stream prompts the user to capture media and to assign each instance of the captured media into one of a plurality of predefined categories, and wherein the predefined categories relate to (i) the location of a vehicle in which an animal is trapped, and (ii) identifying characteristics of the vehicle; (c) receiving captured and categorize media in response to the dialog stream; and (d) forwarding the captured media to an authority tasked with animal rescues.

In yet another aspect, a method for rescuing an animal trapped in a vehicle is provided. The method comprises (a) providing an application for a mobile communications device; (b) generating a dialog stream with the user upon launch of the application, wherein the dialog stream prompts the user to capture media and to assign each instance of the captured media into one of a plurality of predefined categories, and wherein the predefined categories relate to at least one parameters elected from the group consisting of (i) the location of a vehicle in which an animal is trapped, and (ii) identifying characteristics of the vehicle; (c) receiving captured and categorize media in response to the dialog stream; and (d) forwarding the captured media to an authority tasked with animal rescues.

In still another aspect, a method is disclosed herein for reporting an event of a predefined type to a responding party which is tasked with responding to events of that type. The method comprises (a) providing a community of users, wherein each user in the community of users is equipped with a mobile technology platform having an instance of a software application installed thereon which allows the user to create an event of the predefined type and to report the created event to the responding party; (b) receiving, from a first member of said community of users, a request to create an event of the predefined type; (c) in response to the request, creating an event of the predefined type, wherein creating the event includes specifying a geofence for the event; (d) prompting the first user to capture media related to the event; (e) obtaining from the first user, or from the mobile technology platform associated with the first user, information related to the event; (f) associating with the event the information obtained from the first user; (g) associating the media captured by the first user with the event if the captured media was captured within the geofence associated with the event; (h) notifying the responding party of the creation of the event; and (i) transmitting to the responding party the captured media and the information input by the first user.

In yet another aspect, a method is provided for reporting an event of a predefined type to a responding party which is tasked with responding to events of that type. The method comprises (a) providing a community of users, wherein each user in the community of users is equipped with a mobile technology platform having an instance of a software application installed thereon which allows the user to create an event of the predefined type and to report the created event to the responding party; (b) receiving, from at least one member of said community of users, a request to create an event of the predefined type; (c) in response to the request, creating an event of the predefined type, wherein creating the event includes specifying a geofence for the event; (d) obtaining, from at least one member of said community of users or from at least one mobile technology platform associated therewith, information related to the event; (e) associating the obtained information with the event; (f) associating, with the event, media captured by at least one member of the community of users, if the captured media was captured within the geofence associated with the event; (g) notifying the responding party of the creation of the event; and (h) transmitting the captured media and the information to the responding party.

In a further aspect, a tangible, non-transient, computer readable medium is provided having programming instructions recorded therein which, when executed by at least one computer processor, implement any of the foregoing methods.

### DETAILED DESCRIPTION

Once an animal becomes trapped in a vehicle in dangerous conditions, the window of opportunity which exists during which the animal may be successfully rescued without harm is frequently quite short. Many jurisdictions allow for public resources, such as the 911 emergency call center, to be utilized to report incidents of animals trapped in vehicles. However, the response time in such situations is often insufficient to avoid harm to the animal or death. In particular, allocation of resources may force emergency authorities to assign a lower level of priority to such calls, resulting in a longer response time than is the case with human emergencies. This places even more of a premium on the ability of the emergency responders to quickly locate an animal in distress.

Unfortunately, in a typical animal rescue response, precious time may be wasted in locating the vehicle in which an animal is trapped. This may occur, for example, because a member of the public reporting the incident may have provided insufficient or inaccurate information about the vehicle in which the animal is trapped and its location. This may be the result of the person being unaccustomed to making such reports, or being distracted by the stress of the situation.

The foregoing problems are not limited to animal rescue. According to a report published by KidsAndCars.org, on average, 38 children die in hot cars each year from heat-related deaths after being trapped inside motor vehicles.

More generally speaking, the same issues are frequently encountered whenever members of the general public or a group of particular individuals are suddenly tasked with reporting information on an incident or a developing situation. Recent examples include terrorism events such as the Boston Marathon bombing and the San Bernardino shootings, the flooding of New Orleans as a result of Hurricane Katrina, and the various cases of alleged police brutality which have been recently reported in the media. In each of these instances, members of the general public found themselves in situations where they possessed information vital to the rapid and effective response to the event by authorities. However, due to faulty, insufficient or delayed reporting of the incident by such persons, the ability of authorities to respond effectively was compromised, sometimes with tragic consequences.

In many cases, faulty reporting of the incident is due to the fact that the person reporting an incident may be unsure or unaware of which details of the incident can or should be included in the report, or may be too distracted to properly tend to such details. For example, such a person may fail to note critical details concerning the time and location at which the event occurred. The lack of such details may hamper the ability of a responding party to respond effectively to the event.

It has now been found that some or all of the foregoing issues may be addressed with the systems and methodologies disclosed herein. In a preferred embodiment, these systems and methodologies utilize a mobile application, possibly in conjunction with an associated web service, to report animals in distress and to facilitate their rescue. The application, which is preferably installed on a mobile communications device or mobile technology platform associated with a user, may leverage technologies that have been developed in the art to create events and to associate media with the created events. These include, for example, the systems, methodologies and software disclosed in U.S. 2013/0275505 (Gauglitz et al.), entitled “Systems and Methods for Event Networking and Media Sharing”, which is incorporated herein by reference in its entirety.

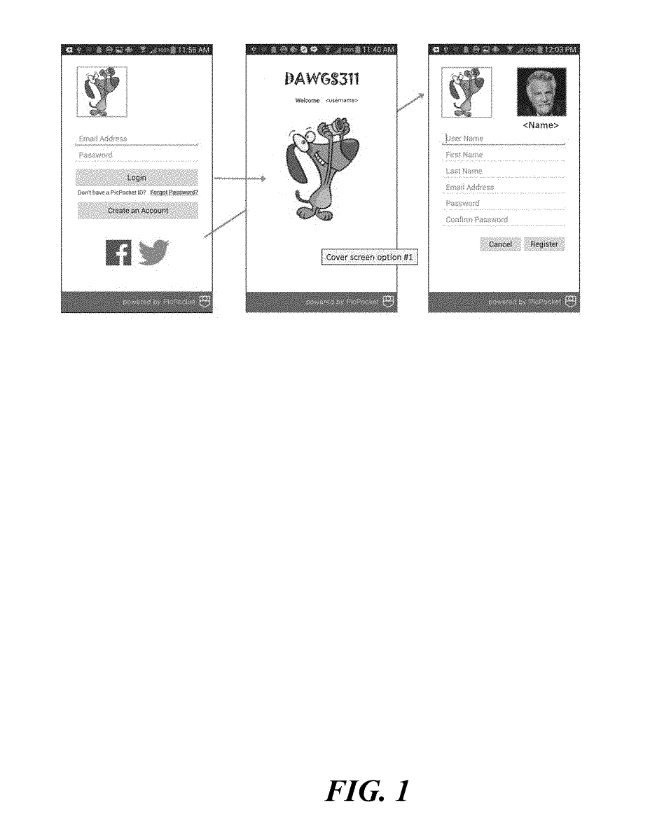

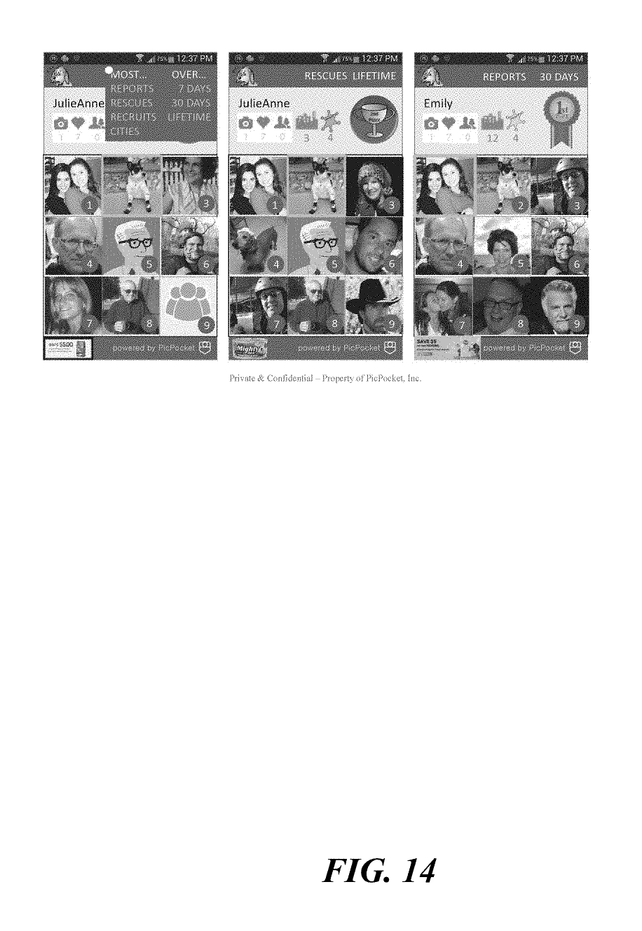

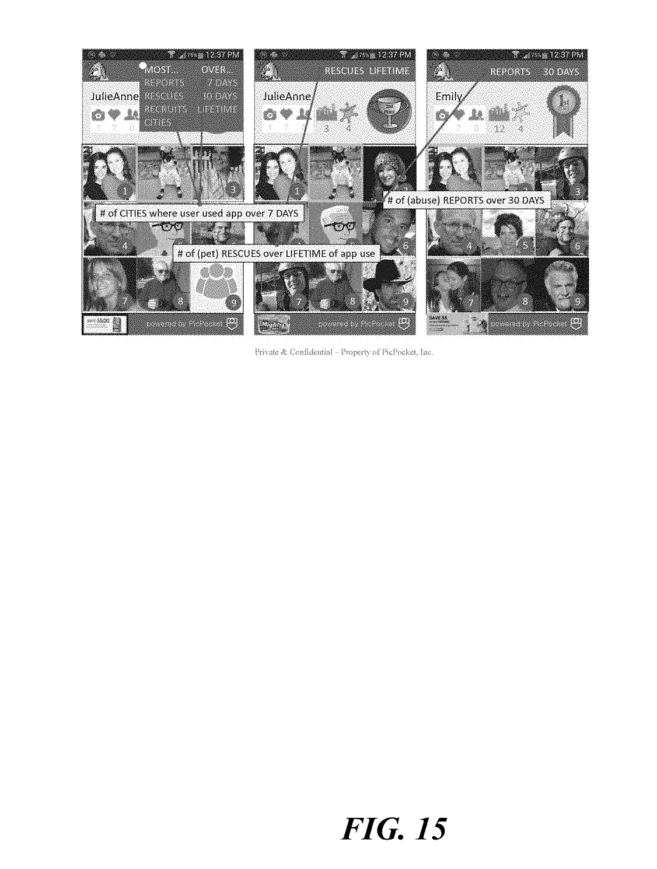

The systems, methodologies and software disclosed herein may be further understood with reference to the particular, non-limiting embodiment depicted in FIGS. 1-15. However, while this particular embodiment is specifically concerned with a system for facilitating animal rescue, it will be appreciated that the systems, methodologies and software disclosed herein are more broadly applicable to a wide variety of situations in which it is desirable to aggregate information and media related to one or more events, and to make the aggregated information and media available to an interested party (such as, for example, a party responsible for responding to the event).

FIGS. 1-15 are screenshots illustrating a first particular, non-limiting embodiment of a software application which may be utilized to implement or facilitate the systems, methodologies and software disclosed herein for facilitating animal rescue. The application is preferably a mobile application which may be downloaded to the mobile communications devices or mobile technology platforms of a community of users. Such downloads may occur, for example, by way of one or more suitable online sites such as, for example, the iTunes Store™, Google Play™, or other such application stores or sites.

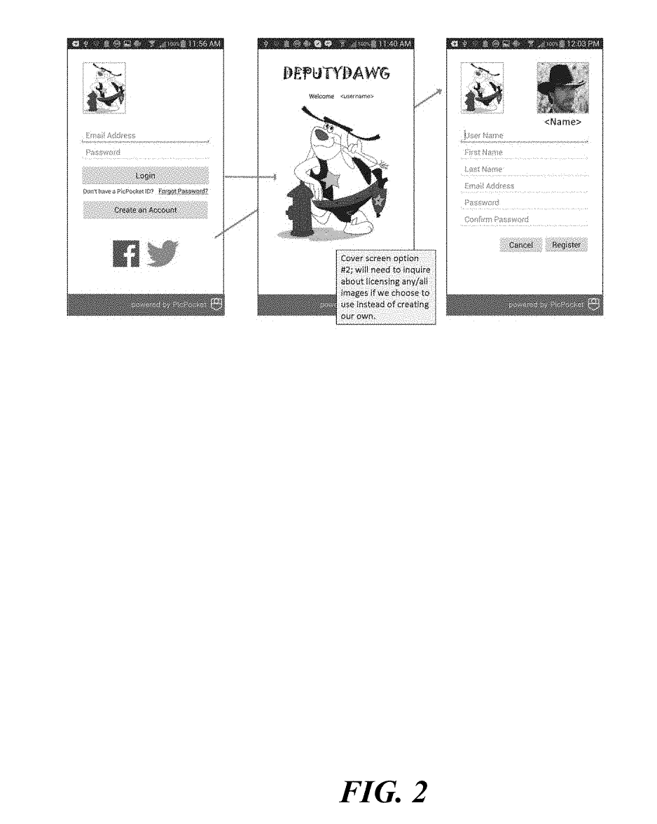

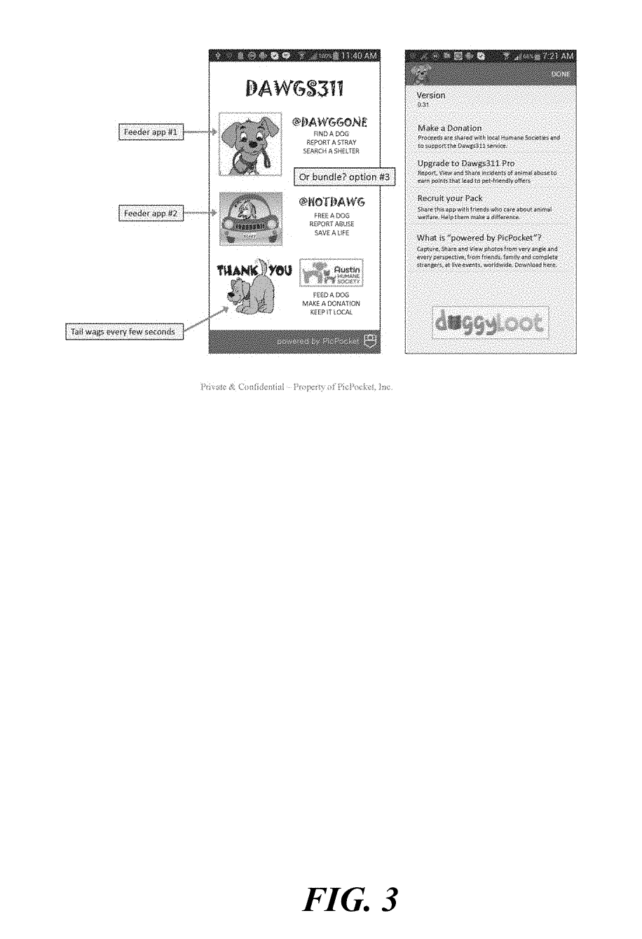

Each user within the community of users register with and/or logs into the application (or web service) associated with the application using one of the alternative windows depicted in FIGS. 1-2. The application may be accessible from within another application. Thus, as shown in FIG. 3, the application (entitled “HotDawg” in this embodiment) may be bundled with other applications on a common launch screen. The informational screen on the right may be accessed through a settings icon from within the application that may be visible on the screen (usually in the top toolbar), by using a suitable menu or button (such as, for example, the Android “Menu” button that is standard on Android phones) or by selecting the “DONATE” icon next to the tail-wagging dog.

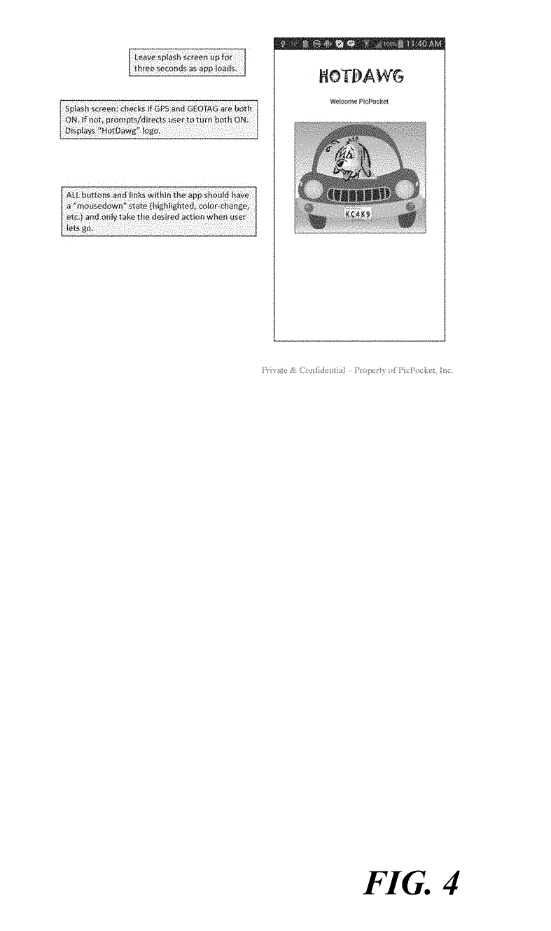

As seen in FIG. 4, in the particular embodiment depicted, a splash screen is displayed while the application is loading, preferably for a period of up to 3 seconds. Upon launch, the application checks if the location awareness features of the host device are activated and, if so, preferably refreshes these features. Preferably, the location awareness features will include suitable features of the host device that allow it to determine its location. This location may be specified, for example, in terms of a set of GPS coordinates or through other suitable means.

Also upon launch, the application checks if the image tagging features of the host device are activated and, if so, preferably refreshes these features. Preferably, the image tagging features will include suitable features of the host device that allow it to tag captured images with metadata or other identifying information. Such identifying information may include the time and date on which the media was captured, the location of the host device (preferably in terms of GPS coordinates) at the time of media capture, local temperature and weather information (this may be gathered from a sensor integrated into the host device, or by referencing the location, date and time information relating to an incident with a third-party service which tracks and collects this information), and possibly information which identifies the host device itself.

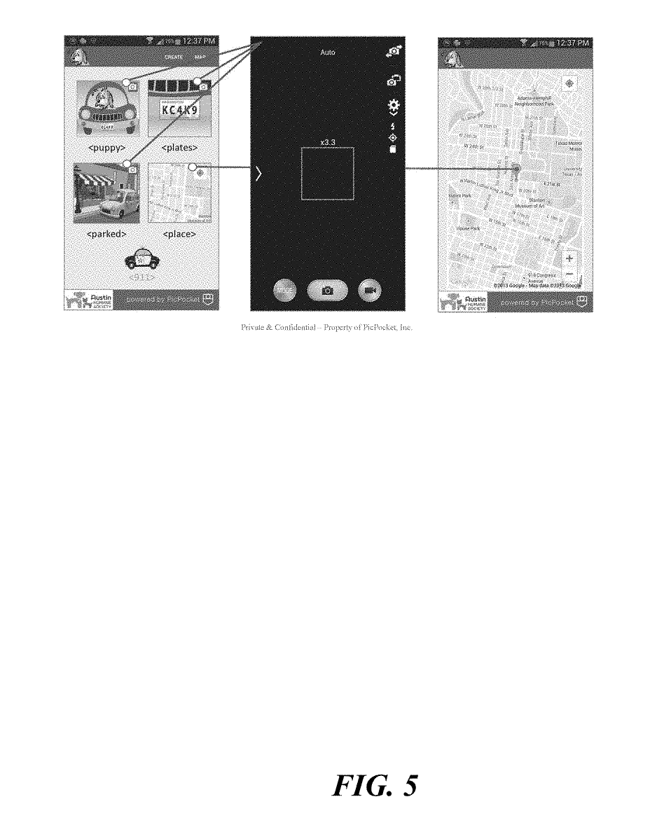

FIG. 5 depicts the main information gathering screen of the application. As seen therein, this screen contains a series of input categories which a user may select to provide information relating to an animal in distress. Thus, in the particular embodiment depicted, the user may select the categories “puppy”, “plates” or “parked”.

Selection of one of the aforementioned categories will launch image capture software (depicted by the middle frame of FIG. 5) so that the user may capture images which will be assigned to that category. Thus, for example, the user may select the “puppy” category to capture images of a trapped animal. The user may select the “plates” category to capture images of the license plates of a vehicle an animal is trapped in. The user may also select the “parked” category to capture images of the location at which the vehicle may be found. The number of images a user may capture for each category, and the size of these images, is not particularly limited. However, in some embodiments, maximum values may be specified to conserve storage or computational resources.

After the user is finished capturing images for one of the categories, the user may utilize suitable navigational icons (e.g., “back” arrows) in the software to return to the main information gathering screen of the application. It will be appreciated that each of the categories may be populated with images using this approach.

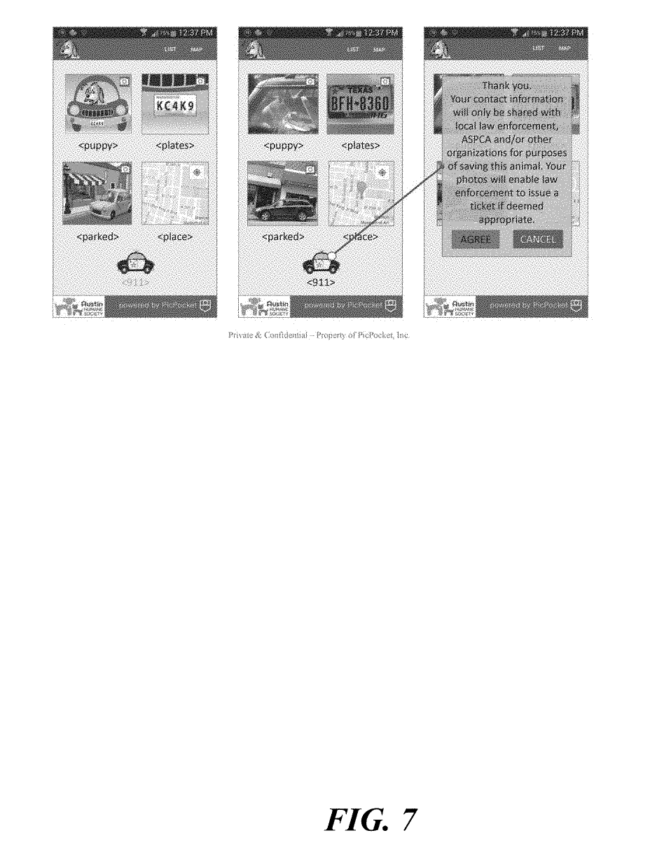

As seen in FIG. 7, upon capturing at least one image in a category, the icon representing that category is preferably replaced by a thumbnail version of an image assigned to that category. The image utilized for this purpose may be designated by the user, or may be selected by default (e.g., the software may be configured to use the first image in that category or the most recent image, or may randomly select an image from the category).

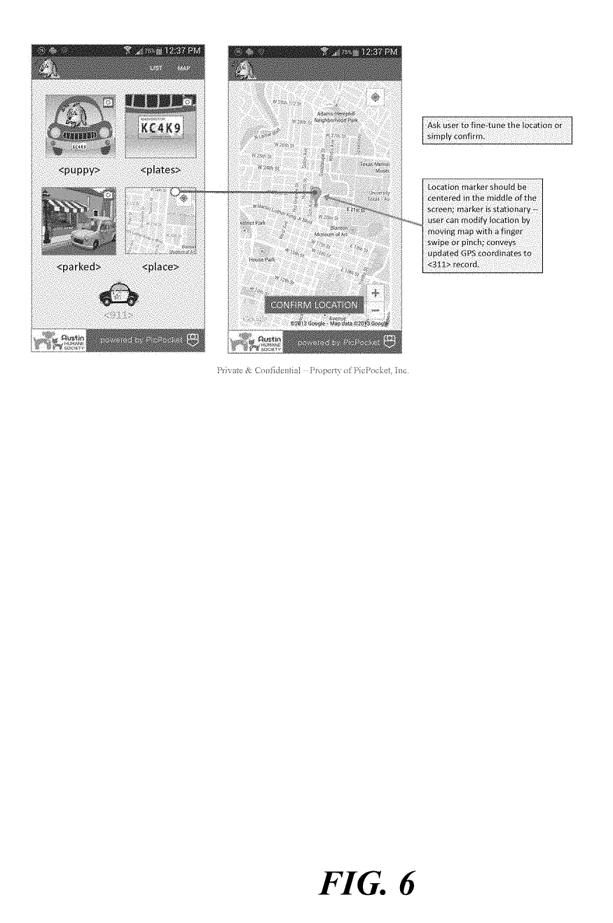

In the particular embodiment depicted, the software also includes a “place” category. As seen in FIG. 6, selection of this category launches a zoomable map which depicts the current location of the user thereon by way of a suitable icon or marker. Preferably, this icon or marker is centered on the map by default, and the map itself is movable by the user (e.g., through selection of suitable navigational icons such as arrows, or by finger-swiping or pinching the map in a desired direction). The user is alerted that they can move the map underneath the fixed icon or marker so as to give as precise an indication of the intended, depicted location as possible. However, in some embodiments, either instead of or as an alternative to the foregoing, the icon or marker which will be made to correspond to the depicted location may itself be movable on the map. Preferably, if the user does not select the place category, the program will ask the user to verify the depicted location to ensure accuracy.

In some embodiments, if the user does not actively update the location awareness features of the mobile communications device or mobile technology platform, the mobile application may prompt the user to do so (in some cases, this may simply involve requesting the device or platform to refresh the determined location). The mobile application may also prompt the user to update the location awareness features at the time of media capture or periodically over the course of time. This may help to ensure that any location information associated with captured media is accurate.

Each instance of media captured by the user will be tagged with relevant identifying data using the media tagging information described above. The information the captured media is tagged with is preferably in addition to any metadata that is otherwise associated with the captured media by the host device. The information may be sent embedded within the media itself, or separately where the metadata is associated with specific content.

When a user has completed capturing all requested or desired media, the user may then submit the media to a suitable authority such as, for example, a local law enforcement agency or an animal rescue organization. Preferably, this is accomplished through suitable messaging (which may include, for example, texts, mms, sms, email, instant messaging or Twitter) with the captured media as attachments thereto, as the targets of an embedded link, or by other suitable means. More preferably, the message may be shared with the authority as an event from within an instance of the same application which the user has used to capture the information. In the particular embodiment depicted, this is accomplished automatically by selection of the icon labeled “911”. As part of the process, selection of this icon launches the rightmost screen depicted in FIG. 7 in which the user is notified that the user's contact information will be shared only with local law enforcement agencies and organizations to effect rescue of the animal. This notification preferably reminds the user that law enforcement authorities may utilize the captured images to issue citations, to prosecute the responsible parties, or for other such purposes, and provides the user with the opportunity to accept or decline these terms. Once the user accepts these terms (e.g., by selecting the “agree” button in the embodiment depicted), the tagged images are sent to (or authorized for viewing by) the appropriate authorities.

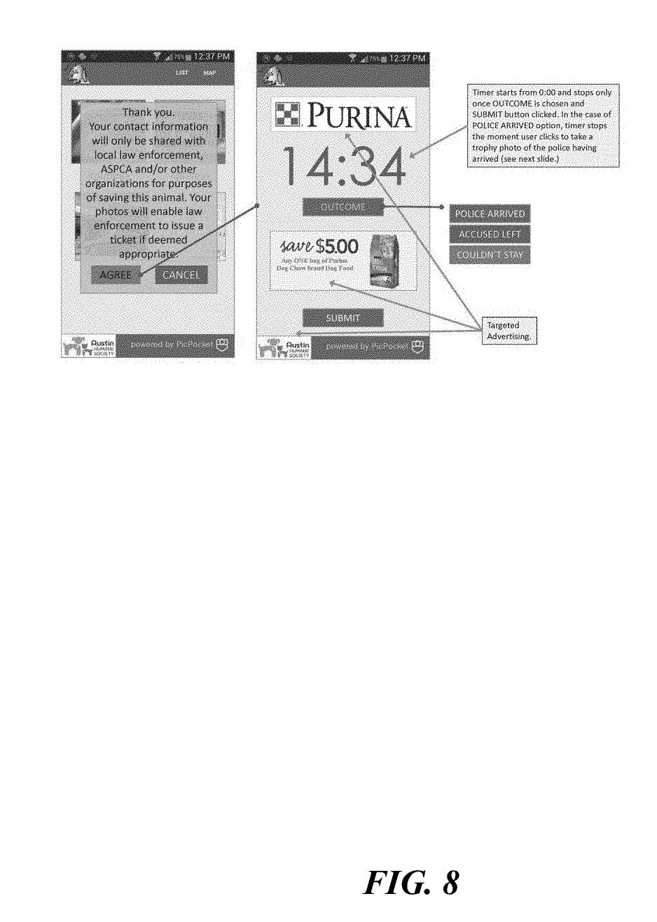

After submission, the software initiates a timer, and the elapsed time is displayed as shown in FIG. 8. The timer continues to run until the “outcome” tab is selected by the user. Upon selection of this button, a menu is launched from which the user may select “Police Arrived”, “Accused Left” or “Couldn't Stay”. During this time, the user may be subjected to various targeted advertising. In some embodiments, the user's participation in the service may be encouraged by offering the user discounts and special offers in place of, or as part of, the targeted advertising.

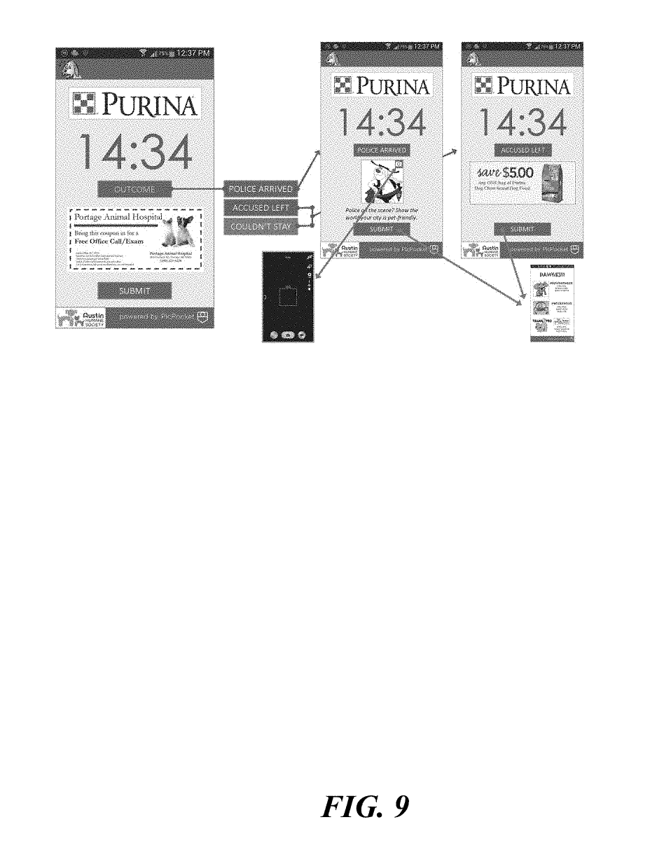

As seen in FIG. 9, if the “Police Arrived” tab is selected, a window is launched from which the user can capture a “trophy” image of the scene. A “Submit” button is provided, the election of which allows the user to publish this image to a network or to otherwise share it with parties of interest. Such sharing may occur via commonly used social-media sites such as Facebook, Twitter, Snapchat and Instagram or, for example, through a media sharing network of the type described in U.S. 2013/0275505 (Gauglitz et al.), entitled “Systems and Methods for Event Networking and Media Sharing”, which is incorporated herein by reference in its entirety.

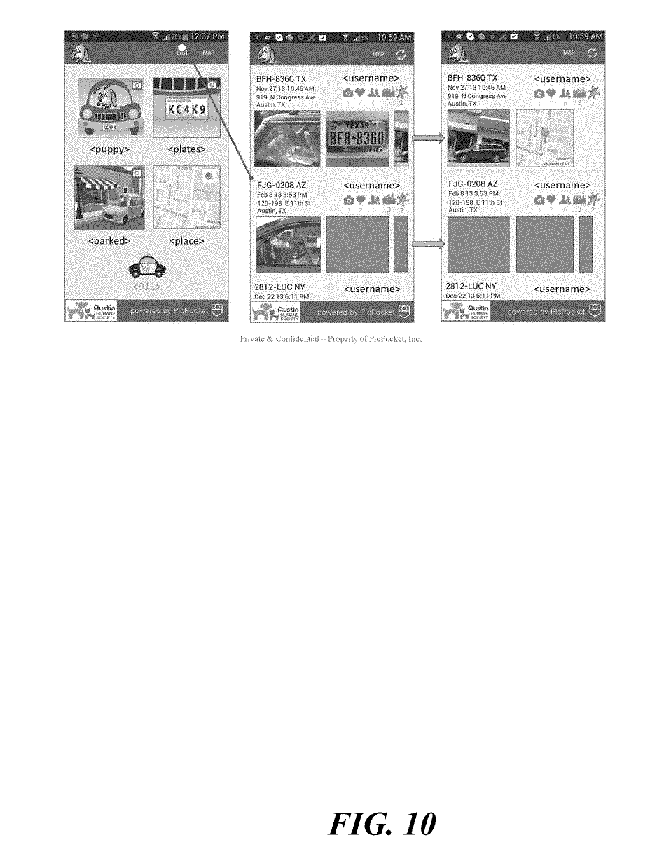

FIG. 10 shows some examples of the information which may be made available to law enforcement authorities and other such parties using the systems and methodologies described herein. As seen therein, the software provides a running list to such parties of trapped animal incidents. Each item in the list includes (if available) the location of the vehicle in which the animal is trapped, the time the incident was first reported, the license plate of the vehicle in which the animal is trapped, a map of the vehicle's location, images of the trapped animal, and other information which may be useful or required in locating the vehicle. In the particular embodiment depicted, each item on the list is scrollable sideways to display additional images or information concerning the incident.

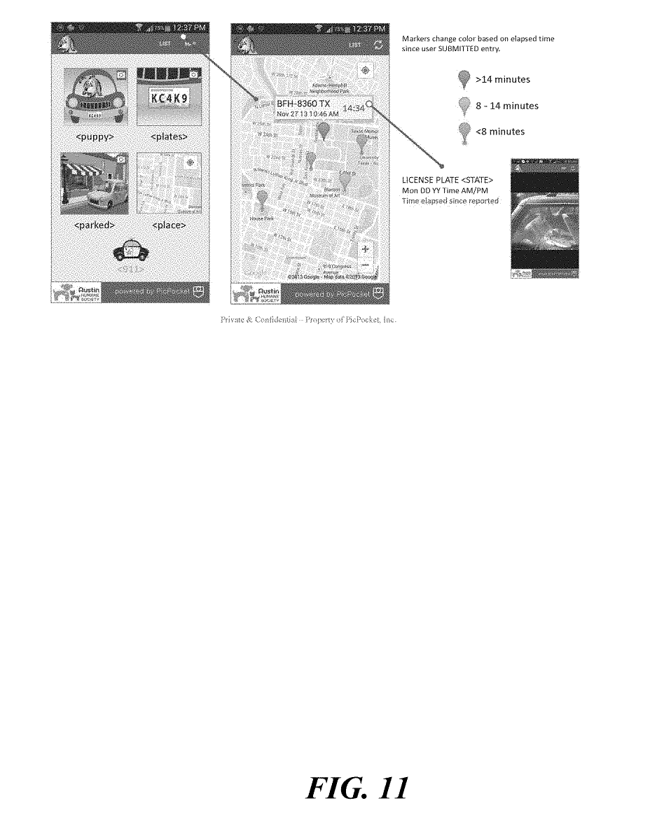

As seen in FIG. 11, the mobile application (or an associated web application or web service) may employ suitable icons, color coding or other means to indicate the criticality associated with each incident, so that treatment of the incidents may be effectively prioritized. In the particular embodiment depicted, this is accomplished, for example, by providing a map on which a suitable marker associated with each reported incident appears. The markers are preferably color-coded to indicate the amount of time that has elapsed since each incident was reported. Thus, for example, the markers may have a first color within the first x minutes, a second color within the range of x to x+y minutes, and a third color when more than x+y minutes have elapsed. By way of example but not limitation, x in this example may be 8 minutes, and y may be 7 minutes, although it will be appreciated that values for these or other parameters may be dictated by intended use, current conditions and other such considerations.

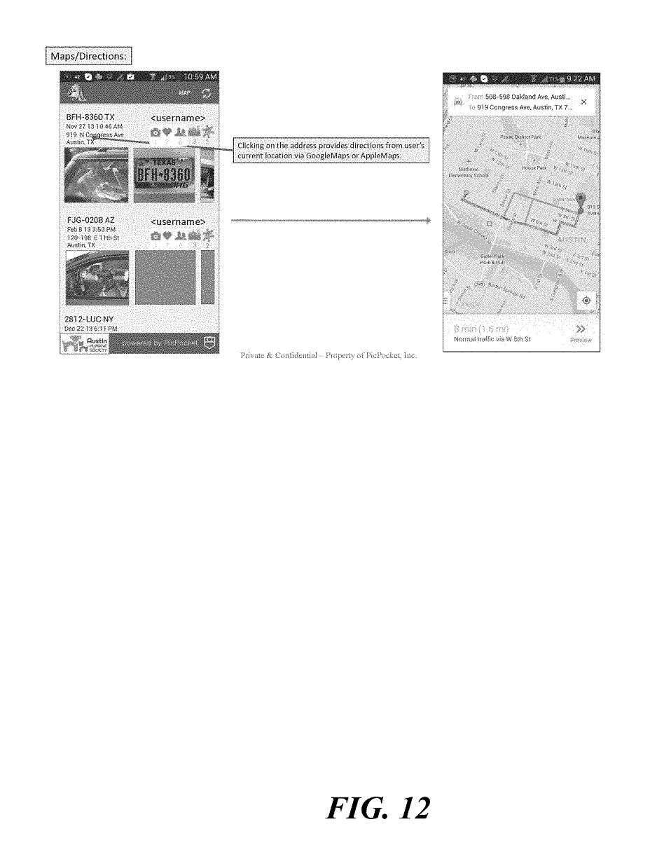

As seen in FIG. 12, an address in the listing may be selected by the user. Doing so launches a suitable program, subroutine or procedure that provides directions from the user's current location to the location of the incident. Such a program, subroutine or procedure may invoke an external mapping or navigational service such as, for example, GoogleMaps™, AmazonMaps™ or AppleMaps™. It will be appreciated that the foregoing feature may be used by local law enforcement or other parties involved in animal rescue to arrive at the location of the incident as promptly as possible.

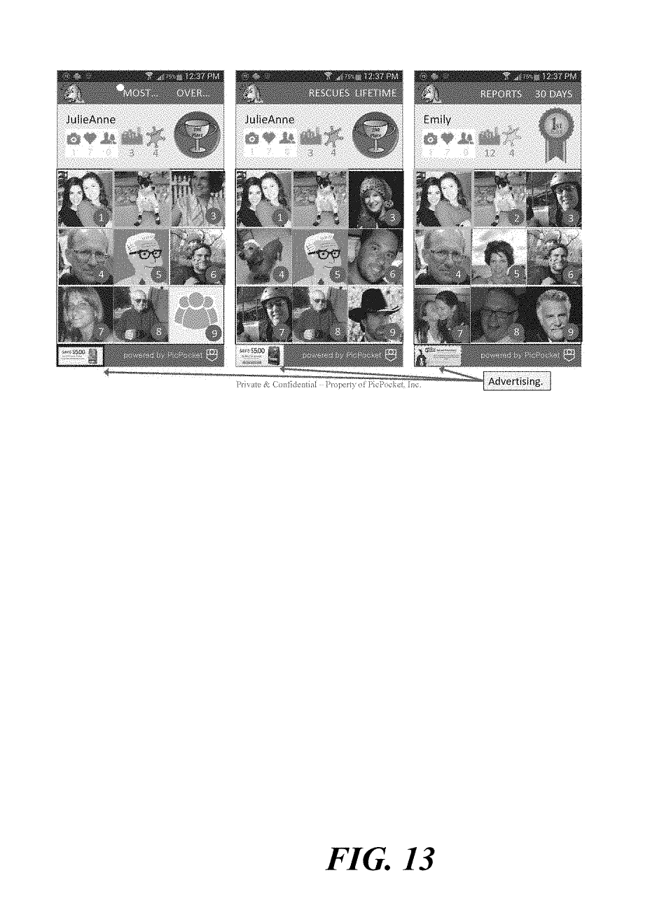

As seen in FIGS. 13-15, the software may be equipped with various reporting features to provide reports on the users of the program. Such reports may specify, for example, the number of cities where the user has used the application over the last 7 days, the number of animal rescues the user has facilitated over the lifetime of their use of the application, and the number of abuse reports generated over the last 30 days as a result of the user's actions.

While it is preferred that media is captured and assigned to categories during use of the mobile application in the manner described above, it will be appreciated that embodiments are also possible in which media capture may occur outside of use of the mobile application, and that media may be assigned to categories after capture of the media has occurred.

It will further be appreciated that, while the systems and methodologies disclosed herein are preferably implemented with a mobile application, these systems and methodologies may be implemented in other manners as well. Thus, for example, these systems and methodologies may be implemented over a website, as a web application, with a web-based service, through the use of software in forms other than mobile applications, or through combinations or sub-combinations of the foregoing. It will also be appreciated that these systems and methodologies may be implemented as a distributed application in which some of the functionality of the software is performed on the client device, while other functionalities of the software may be performed on one or more remote servers or other remote computational devices.

It will be appreciated that various embodiments of the systems and methodologies disclosed herein may be adapted to allow the user to enter various identification features of, for example, a vehicle of interest (e.g., a vehicle in which an animal is trapped). Thus, for example, in addition to entering license plate information, in some embodiments, the user may be able to enter a vehicle identification number (VIN) (also sometimes referred to as a chassis number). The VIN is a unique code (including a serial number) which is used by the automotive industry to identify individual motor vehicles.

It will also be appreciated that, in some embodiments of the software, systems and methodologies disclosed herein, various other information may be captured and/or transmitted to authorities or appropriate third parties. Such other information may include, for example, the date, time, local weather, and surroundings. By way of example, images, video or audio files of the area surrounding or adjacent to the event being reported may be captured by the user and transmitted to authorities. Thus, for example, in an animal rescue situation, the user may be prompted to capture images or video of nearby street intersections, shopfronts or other identifiable features to facilitate rapid location of the animal. This information, or details associated with it, may be embedded (e.g., through the use of suitable metadata) in the captured media or may be otherwise associated with it.

In some embodiments of the systems and methodologies disclosed herein, the software utilized in these systems and methodologies may be equipped with voice recognition capabilities. In such embodiments, keyword triggers may be utilized to rapidly access a particular window or functionality within the software. For example, by uttering a phrase such as “PicPocket Police”, the user may access the particular window or functionality within the software that allows the user to report an event to the police. The software may similarly be equipped with the ability to allow the user to input keywords, by way of a keypad or other suitable input device, to similar effect. It will be appreciated that the software may have the ability to allow the user to report a variety of events to a wide spectrum of parties responsible for responding to events of a particular type. Hence, this feature may allow the user to rapid access the appropriate portions of the software required to report an event of a specific type without having to wade through unnecessary windows or menus.

It will be appreciated that the systems, methodologies and software described herein may be deployed across a wide variety of mobile communications devices and mobile technology platforms. These include, without limitation, mobile or cellular phones, personal digital assistants, laptop computers, notebooks, smartwatches, smart glasses, handheld communications devices, wearables equipped with computational or communications abilities (including contact lenses), and the like. For purposes of this disclosure, the modifier “mobile”, as used in “mobile technology platform” and mobile communications device”, denotes a device that weighs less than 10 lbs, and typically weighs no more than 6.5 lbs.

The systems, methodologies and software disclosed herein may use various features of the systems, methodologies and software disclosed in U.S. 2013/0275505 (Gauglitz et al.), entitled “Systems and Methods for Event Networking and Media Sharing”, which is incorporated herein by reference in its entirety; in U.S. 20130117146 (Gauglitz et al.), entitled “System and Methods for Event Networking, Media Sharing, and Product Creation”, which is incorporated herein by reference in its entirety; in WO2016040680 (Gauglitz), entitled “SYSTEMS AND METHODOLOGIES FOR VALIDATING THE CORRESPONDENCE BETWEEN AN IMAGE AND AN ASSET”, which is incorporated herein by reference in its entirety; in PCT/US2015/066257 (Gauglitz), entitled “DRONE BASED SYSTEMS AND METHODOLOGIES FOR CAPTURING IMAGES”, which is incorporated herein by reference in its entirety; and in U.S. Ser. No. 14/988,564 (Gauglitz), entitled “Use of a Roaming Geofence to Control Media Sharing and Aggregation Associated With a Mobile Target”, which is incorporated herein by reference in its entirety. For example, the geofences described herein may be roaming geofences of the type described, for example, in U.S. Ser. No. 14/988,564 (Gauglitz). Similarly, the captured media described herein may be captured with a drone-based system as described, for example, in PCT/US2015/066257 (Gauglitz).

Various embodiments of the systems described herein may be moderated or unmoderated. In moderated systems, the moderator may be charged, for example, with approving or monitoring requests for event creation, approving or monitoring authorized users of the system, or approving or monitoring media or information shared over the system.

In some embodiments, use of the system or software may be restricted to a set of trusted users, or visibility of, or notifications related to, an event may be restricted to a particular set of users. For example, in some embodiments, use of the system or software may be restricted to a particular entity or entities, or to personnel associated with, vetted by, registered with, or otherwise trusted by such entities. For example, in some embodiments, use of the system or software may be restricted to law enforcement personnel or emergency responders. In some embodiments, use of the system may be split between two or more groups, with each group possibly having its own distinct set of access or use privileges. For example, in some embodiments, only law enforcement personnel may have the ability to create an event, but members of the general public may have the ability to monitor events or to contribute media to an event or vice-versa.

It will be appreciated that the systems, methodologies and software disclosed herein may interface with, link to, or utilize various other products, social media platforms, or technologies. For example, the systems, methodologies and software disclosed herein may generate alerts or notices which are sent out across social media platforms such as Facebook or Twitter. In some embodiments, such alerts or notices may be sent to users of such social media platforms which subscribe to or follow a particular feed, user or homepage. Thus, for example, users (such as, for example, members of the media or general public) who follow the Austin Police Department may be notified when events, or certain subsets or categories of events, are created which the Austin Police Department is tasked with responding to, or when captured media is associated with such events. Such alerts or notices may also be sent to various parties of interest through various messaging forums or types. Thus, for example, such alerts may be broadcast across communication or social media platforms such as Twitter or Facebook, and may be sent in SMS, MMS, email, or text formats.

It will also be appreciated that, in some embodiments of the systems and methodologies disclosed herein, alerts or notices related to an event may be directed to parties with potential interest in the event. For example, a user of the system may be given notices of events which have been created, or which are ongoing, and which are proximal to the user's current location (as determined, for example, by location awareness functionalities resident on a mobile communications device or mobile technology platform associated with the user). Similarly, a user of the system may be given notices of events of a type which the user has expressed interest in (as, for example through appropriate software menu selections or entries made by the user, or based on events which the user has previously created or contributed media or information to).

It will further be appreciated that, in some embodiments of the systems, methodologies and software disclosed herein, the responding party may be a passive party with respect to the creation of events and the aggregation of media. For example, the systems, methodologies and software may be implemented over a social media platform in which the users or a third party control the creation of events and the aggregation of media, and in which the responding party merely subscribes to the system or software (or an appropriate feed produced thereby) so that the responding authority can take appropriate action when they deem it necessary. By way of example, while animal rescue may be an appropriate function of the responding party, it may be of secondary importance to the responding party. Hence, the responding party may monitor the system or software (or a feed produced thereby) only when it has sufficient bandwidth to respond to events of that type.

The systems, methodologies and software disclosed herein may be directed to reporting events of a specific type (such as, for example, the animal rescue software described herein), or may be styled as a more generalized platform over which a variety of different event types may be reported. Each event type may have one or more predefined templates associated with it which governs information or media which is preferred or required to be input or captured by the user. For example, in one embodiment, the system may be a web-based system in which the user is presented with one or more web pages equipped with fields which show the information or media already input by the user, and any missing information or media which is preferred or required in order for the responding party to effectively respond to the event. Examples of such web pages are depicted in FIGS. 10-12, it being understood that this approach may be utilized with a wide variety of events, and not just animal rescue.

The systems, methodologies and software disclosed herein may also utilize templates which are created or modified in real time by the responding party. Thus, for example, the responding party may create or modify a template to allow the responding party to better respond to an event which may be developing or fluid in nature. By way of example, if police are especially interested in images or video of a getaway vehicle used in an armed robbery, the template for reporting the event may be modified to include a special field for photos or video entitled “getaway vehicle”, and the responding entity may prioritize consideration of reports in which that particular field is populated. This approach may be utilized, for example, to allow the responding entity to sort through a potentially large number of reports in a short amount of time to identify those reports most likely to be of current interest. Similarly, the template may be updated with photos of the suspected perpetrators to aid members of the public in determining the suspects' whereabouts.

The systems, methodologies and software disclosed herein may be used in conjunction with a wide variety of responding parties. The responding party may be a municipality, utility, or a local, state, federal or international agency, organization or service. For example, the responding party may be a law enforcement agency (such as, for example, the local or state police, the FBI, Interpol, or the like) or law enforcement personnel, an emergency response team (such as, for example, FEMA, Red Cross, a paramedic squad, a fire department, or a ski patrol), an animal rescue organization, a utility (which may use the system or software to, for example, allow members of the general public to report gas leaks, downed power lines, broken water mains, or service disruptions), or the like.

It will be appreciated that the definition of an event (and in particular, the definition of a geofence associated with an event) in the systems, methodologies and software disclosed herein may change over time. For example, it may be determined that two ostensibly distinct events are actually part of the same event. Upon such a determination (which may be made, for example, by a moderator or by the system or software itself), the two events may be merged into a single event or they may be linked. Similarly, an event may be split into two or more distinct events or subevents.

By way of example, a first user may report the robbery of a nearby convenience store, and a second user may report a car accident several blocks away. It may be determined (by license plate images or other information) that the same vehicle was involved in both incidents, in which case the events may be merged or otherwise linked so that information or media associated with one of the events will also be associated with the other event. Similarly, a shoplifting incident in the convenience store which occurred prior to the armed robbery (and which was originally associated with the armed robbery based on location) may later be determined to be a wholly unrelated event, and may be disassociated from the armed robbery event (e.g., by specifying a temporal window for the shoplifting incident which does not overlap with the armed robbery incident).

It will also be appreciated that the perimeter of a geofence may evolve over time. For example, as noted above, two or more geofences may be determined to belong to the same event, in which case the geofences will, in the aggregate, form the geofence for the event. These geofences may overlap, or may be discrete. Alternately, if it is determined that two or more different locations belong to the same event, the geofence for the event may be redrawn to cover the multiple locations (as, for example, by using a least squares approach to drawing a circle that encompasses all of the locations). As still another possibility, the addition of new locations to an event may result in the formation of a complex or irregularly shaped geofence for the event.

In some embodiments of the systems, methodologies and software described herein, flags may be utilized to designate sets of users to whom an event, or the information or media associated with an event, will be visible. By way of an example, both members of the general public and members of a local police force may be provided with instances of the same software. When events are created which are of a type which local police are tasked with responding to, those events may be appropriately flagged so that those events (and preferably, only those events) are visible to a member of the local police who is utilizing the software. In this manner, local law enforcement may utilize the same version of the application utilized by members of the general public. However, the flags serve a filtering function so that only events appropriate for local law enforcement will be visible to members of the local police (thus, for example, social events created by users will preferably not be visible to members of the local police).

Conversely, flags may be utilized to ensure that some events are visible only to members of a set of trusted users. For example, if a member of a local police force creates an event relating to a drug bust, it will typically be desirable for that event to not be visible to members of the general public. This result may again be achieved through the suitable use of appropriate flags.

It will be appreciated that the foregoing use of flags is very desirable. In particular, it obviates the need to produce different versions of the software to accommodate different groups of users who use the software in different ways. Instead, the appropriate use of flags allows the same software to be utilized in different ways by different sets of users. The use of flags, or other suitable means to control the visibility of events, may be implemented or governed by suitable software settings, some or all of which may be set by the user or by appropriate authorized parties.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1-60. (canceled)

61. A method for reporting an event of a predefined type to a responding party which is tasked with responding to events of that type, the method comprising:
providing a community of users, wherein each user in the community of users is equipped with a mobile technology platform having an instance of a software application installed thereon which allows the user to create an event of the predefined type and to report the created event to the responding party;
receiving, from at least one member of said community of users, a request to create an event of the predefined type;
in response to the request, creating an event of the predefined type, wherein creating the event includes specifying a geofence for the event;
obtaining, from at least one member of said community of users or from at least one mobile technology platform associated therewith, information related to the event;
associating the obtained information with the event;
associating, with the event, media captured by at least one member of the community of users, if the captured media was captured within the geofence associated with the event;
notifying the responding party of the creation of the event; and
transmitting the captured media and the information to the responding party.

62. The method of claim 61, wherein defining the event includes specifying a temporal window for the event.

63. The method of claim 62, wherein the captured media is associated with the event if it was captured within the temporal window associated with the event.

64. The method of claim 61, wherein information obtained from a member of the community of users is only associated with the event if media captured by that user has been associated with the event.

65. The method of claim 61, wherein information obtained from a member of the community of users is only associated with the event if the user's location meets a set of criteria established for the event.

66. The method of claim 65, wherein the set of criteria includes date, time and location.

67. The method of claim 65, wherein the set of criteria includes a location and temporal window.

68. The method of claim 61, wherein each mobile technology platform associated with each user in the community of users is equipped with location and temporal awareness, and wherein obtaining from a user, or from the mobile technology platform associated with that user, information related to the event includes capturing the location of the mobile technology platform at the time the request to create the event was made.

69. The method of claim 68, wherein obtaining from the first user, or from the mobile technology platform associated with the first user, information related to the event includes capturing the time at which the request to create the event was made.

70. The method of claim 61, wherein the responding party is a government entity.

71. The method of claim 61, wherein the responding party is selected from the group consisting of law enforcement agencies and emergency response entities.

72. The method of claim 61, further comprising:
prompting at least one user in the community of users to capture media related to the event;
wherein each mobile technology platform associated with each user in the community of users is equipped with a display, and wherein prompting the at least one user to capture media related to the event includes displaying, on the display of the at least one user's mobile technology platform, an instructional window instructing the at least one user on the type of media to be captured.

73. The method of claim 72, wherein the media to be captured is selected from the group consisting of images, video and audio, and wherein the instructional window specifies the vantage point from which the media should be captured.

74. The method of claim 72, wherein prompting the at least one user to capture media related to the event includes displaying, on the display of the at least one user's mobile technology platform, an instructional window instructing the at least one user on the subject matter of the media to be captured.

75. The method of claim 61, further comprising:
identifying members of the community of users who are proximal to a created event; and
notifying the identified members of the creation of the event.

76. The method of claim 61, further comprising:
identifying members of the community of users who are proximal to a created event and who are trusted; and
notifying and authorizing only the trusted, identified members to view the event.

77. The method of claim 75, wherein each mobile technology platform associated with each user in the community of users is equipped with location and temporal awareness, and further comprising:
receiving, from a member of said community of users, a request to contribute media captured by the second user to the created event;
determining the location at which the media to be contributed was captured; and
associating media captured by the user with the created event only if the media captured by the user was captured within the geofence associated with the event.

78. The method of claim 77, wherein the media captured by the user is associated with the created event only if the media captured by the user was captured within the geofence and a temporal window associated with the event.

79. The method of claim 75, wherein each mobile technology platform associated with each user in the community of users is equipped with location and temporal awareness, and further comprising:
receiving, from a member of said community of users, media captured by the user;
determining the location at which the media to be contributed was captured; and
associating media captured by the user with the created event only if the media captured by the user was captured within the geofence associated with the event.

80. The method of claim 79, wherein the media captured by the user is associated with the created event only if the media captured by the user was captured within the geofence and within a temporal window associated with the event.

81. (canceled)
